(19) United States
(12) Patent Application Publication
(10) Pub. No.: US 2003/0187759 A1
(43) Pub. Date: Oct. 2, 2003

(54) Systems and methods for electronically monitoring fraudulent activity

(75) Inventors: Mark G. Arthus, Nesconset, NY (US); Michael L. Sgaraglio, Massapequa Park, NY (US); William S. Miller, Bayshore, NY (US); Henry M. Abelman, Roswell, GA (US); Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/322,135

(22) Filed: Dec. 17, 2002

Related U.S. Application Data
(63) Continuation-in-part of application No. 10/108,948, filed on Mar. 27, 2002.

(51) Int. Cl. G06F 17/60

(52) U.S. Cl. 705/30

(57) ABSTRACT

A method of monitoring credit fraud relating to a plurality of merchants includes, on a server computer, collecting transaction information relating to the merchants and electronically evaluating the collected transaction information for potentially fraudulent activities using specific criteria. The method further includes flagging merchants having transaction information indicating potentially fraudulent activity. Systems for implementing the method are also provided. The method may include collecting transaction records relating to other electronic accounts and electronically monitoring the accounts using specified criteria for potentially fraudulent activity.

### CROSS-REFERENCES TO RELATED APPLICATIONS

This application is a continuation-in-part of commonly assigned, co-pending U.S. patent application Ser. No. 10/108,948, entitled “SYSTEMS AND METHODS FOR MONITORING CREDIT FRAUD” (Attorney Docket No. 020375-008400US), filed on Mar. 27, 2002 by Mark G. Arthus, et al., which application is incorporated herein by reference in its entirety for all purposes. This application is related to commonly assigned, co-pending U.S. patent application Ser. No. 10/108,781, entitled “DECISION TREE SYSTEMS AND METHODS” (Attorney Docket No. 020375-008200US), filed on Mar. 27, 2002 by Mark G. Arthus, et al., and to commonly assigned, co-pending U.S. patent application Ser. No. 10/108,575, entitled “SYSTEMS AND METHODS FOR MONITORING CREDIT RISK” (Attorney Docket No. 020375-008500US), filed on Mar. 27, 2002 by Michael L. Sgaraglio, and to commonly assigned, co-pending U.S. patent application Ser. No. 10/109,198, entitled “MERCHANT APPLICATION AND UNDERWRITING SYSTEMS AND METHODS” (Attorney Docket No. 020375-007100US), filed on Mar. 27, 2002 by Michael L. Sgaraglio, et al., and to commonly assigned, co-pending U.S. patent application Ser. No. 10/108,934, entitled “MERCHANT ACTIVATION TRACKING SYSTEMS AND METHODS” (Attorney Docket No. 020375-023900US), filed on Mar. 27, 2002 by Michael L. Sgaraglio, et al., and to commonly assigned, co-pending U.S. patent application Ser. No. 10/108,785, entitled “SYSTEMS AND METHODS FOR MANAGING COLLECTIONS RELATING TO MERCHANT ACCOUNTS” (Attorney Docket No. 020375-008300US), filed on Mar. 27, 2002 by Mark G. Arthus, et al., and to commonly assigned, co-pending U.S. patent application Ser. No. 10/091,605, entitled “METHOD AND SYSTEM FOR IMPROVING FRAUD PREVENTION IN CONNECTION WITH A NEWLY OPENED CREDIT ACCOUNT” (Attorney Docket No. 020375-005800US), filed on Mar. 4, 2002, by Randy S. Britton, et al., which applications are incorporated herein by reference in their entirety for all purposes.

### BACKGROUND OF THE INVENTION

This invention relates generally to the field of financial transactions, and in particular to monitoring electronic accounts for potentially fraudulent activity. More specifically, in one aspect the invention relates to periodically reviewing accounts for indications of fraudulent activity and identifying account owners for further evaluation.

Financial transactions involving the use of presentation instruments, such as credit cards, play an important role in today's economy. A typical credit card transaction proceeds by extracting account information from the credit card, typically using a point of sale device at a merchant location, and submitting the account information along with a requested payment amount to a processing system. Such a processing system may involve the merchant's bank, a credit card association, such as VISA or MasterCard, and the issuer's bank as is known in the art.

Hence, in order to process a credit card transaction, a merchant must typically establish an account with a processing organization. Because the processing organization takes on certain financial risks when agreeing to process a merchant's transactions, an application and underwriting process typically takes place before an account is opened. For example, an account may be established by first requiring the merchant to fill out a credit application. The credit application is then sent to an underwriter who reviews information in the application to determine whether the merchant would be a suitable client. If so, the account is established, and the merchant may begin accepting at least certain types of credit cards as payment for their goods or services.

Thereafter, circumstances may change with respect to the merchant that affect the suitability of the merchant as a client. For example, the merchant may begin exploiting the account in a fraudulent manner. Therefore, processing organizations desire to monitor the account history of their merchant clients.

Suspected fraudulent activity may be identified in a number of ways. Excessive charge-back volume, charges or charge backs to a merchant's own credit account, sales of merchandise not within a merchant's line of business, and excessive transaction activity with related accounts are all examples of potentially fraudulent activity. Credit processing organizations may identify theses and other fraud indicators by reviewing the accounts of their merchant clients.

Hence, there is a need in the art for systems and methods that improve the monitoring of credit fraud associated with client accounts.

Of course, credit service providers are not the only entities subject to being victimized by fraudulent activity. For example, money transfer service providers may be victimized by their associates or customers. In fact, most any service provider that entrusts a portion of its business process to others may become the victim of fraud. However, according to the present invention, systems and methods may be employed to identify potentially fraudulent activity.

### BRIEF SUMMARY OF THE INVENTION

Embodiments of the present invention thus provide a method of monitoring credit fraud relating to a plurality of merchants. The method includes collecting transaction information relating to the merchants on a server computer and electronically evaluating the collected information for potentially fraudulent activities using specified criteria. The method further includes flagging merchants having transaction information indicating potentially fraudulent activity.

For example, the specified criteria may include merchants processing at least one transaction involving a personal credit card account owned by the merchant. The specified criteria may also include merchants processing at least one transaction involving goods or services in a different business from the merchant's business. The specified criteria may further include merchants having charge back volumes in excess of charge volumes.

In other embodiments, the method may include receiving at the server computer a request to display at least a partial list of flagged merchants and transmitting the list to a credit fraud investigator. The method may also include receiving a request at the server computer to transmit the structure of a decision tree and transmitting the structure of the decision tree to a credit fraud investigator. A decision tree is a tool that facilitates the completion of tasks, thus allowing less skilled workers to accomplish the tasks. The method may include receiving at the server computer a request from a credit fraud investigator to transmit, for a flagged merchant, merchant information from a file relating to the merchant and transmitting the merchant information to the credit fraud investigator.

In still other embodiments, the method may include receiving at the server computer revised merchant information from the credit fraud investigator and storing the revised merchant information in a database. The method may include receiving at the server computer a request to add the merchant to a watch list. The method may also include receiving at a server computer a request to transmit the merchant information to a collections officer.

In other embodiments of the invention, a system for monitoring credit fraud relating to a plurality of merchants includes a data storage arrangement and a server computer configured to access the data storage arrangement. The server computer is adapted to communicate with at least one other computer through a network. The server computer is configured to collect transaction information relating to the merchants and evaluate the collected information for potentially fraudulent activity using specified criteria. The server computer is further configured to flag merchants having transaction information indicating potentially fraudulent activity.

In still other embodiments, a method for monitoring electronic accounts includes collecting transaction records at a server computer and evaluating the records for potentially fraudulent activity using specific criteria. The method also includes flagging accounts having transaction records indicating potentially fraudulent activity. The accounts may relate to money transfer service providers and their associates, rental service providers and their associates, money order sellers and their associates, bill payment service providers and their associates, and the like. The specific criteria may be seasonally adjusted, temporally adjusted, location adjusted, and the like. For example, using the criteria, the server computer may identify potentially fraudulent activity because of unusual variations from seasonal or daily norms. In other embodiments, such as with respect to money order sales, fraudulent activity may include segmenting money order purchases such that a reporting threshold is not triggered. By evaluating sequential transactions or multiple transactions involving the same person or entity, potentially fraudulent activity may be detected.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a schematic representation of a computer system that may be configured to implement methods of the present invention;

FIG. 2 illustrates a flow diagram according to an embodiment of the present invention;

FIG. 3 illustrates a query display screen for selecting merchant for review according to an embodiment of the invention;

FIG. 4 illustrates a merchant listing screen that lists merchants meeting criteria established using the query display screen of FIG. 3;

FIGS. 5A-5E illustrate a series of display screens for assisting an investigator with completing a credit fraud investigation according to the present invention;

FIG. 6 illustrates a decision tree structure that may be used according to the present invention to assist an investigator with a credit fraud investigation;

FIG. 7 illustrates an add to watch list display screen according to the present invention for adding a merchant to a watch list for future credit fraud review;

FIG. 8 illustrates a report selection display screen according to the present invention;

FIG. 9 illustrates a watch list report query screen according to the present invention; and

FIG. 10 illustrates a watch list report according to the present invention.

### DETAILED DESCRIPTION OF THE INVENTION

Embodiments of the present invention provide systems and methods for credit issuers to monitor potentially fraudulent activity associated with credit services. Additional embodiments provide methods and systems for monitoring electronic accounts for potentially fraudulent activity using specific criteria. This detailed description presents the invention in a non-limiting example relating to credit card processing organizations. Throughout this description, reference is made to certain well known systems, products and processes, such as, for example, the Internet, web sites, web site browsers, databases, and the like, which will not be described in detail in order not to unnecessarily obscure the present invention. In light of this detailed description, those skilled in the art will realize how to make and use the present invention in a number of different embodiments using a range of equivalents to elements discussed herein, all of which are within the scope of the present invention as defined by the claims that follow.

Credit services may be established with essentially any type of person, entity, organization, business, or the like that wishes to take payments for goods or services in the form of a credit, and, for convenience of discussion, are generally referred to herein as “merchants”. Such merchants may process a credit transaction based on an account identifier presented at the time of payment. The account identifier is used to identify the account to which the credit will eventually be posted. In many cases, the account identifier is provided on some type of presentation instrument, such as a credit card, debit card, smart card, stored value card, or the like. Conveniently, the account identifier may be read from a point of sale device, such as those described in copending U.S. application Ser. Nos. 09/634,901, entitled “POINT OF SALE PAYMENT SYSTEM,” filed Aug. 9, 2000 by Randy J. Templeton et al., which is a nonprovisional of U.S. Prov. Appl. No. 60/147,899, entitled “INTEGRATED POINT OF SALE DEVICE,” filed Aug. 9, 1999 by Randy Templeton et al, the complete disclosures of which are herein incorporated by reference. However, the account identifier may be obtained in other ways, such as by visual inspection of the presentation instrument, by telephone, over the Internet, and the like.

The user account information is transmitted to a credit processing service that approves and processes the transaction information and provides payment to the merchant. As is known, various other organizations may also participate in the transaction in order to bill the user for the transaction, including the issuing bank, the merchant's bank, a credit card association, and the like. The credit processing service may also handle “charge backs”, e.g. when the card holder requests a refund and the account is credited. One example of a credit processing service is the service provided by First Data Corporation, Greenwood Village, Colo.

Systems and methods for establishing and maintaining merchant accounts are more fully explained in previously incorporated U.S. patent application Ser. No. 10/109,198, entitled “MERCHANT APPLICATION AND UNDERWRITING SYSTEMS AND METHODS” and in previously incorporated U.S. patent application Ser. No. 10/108,934, entitled “MERCHANT ACTIVATION TRACKING SYSTEMS AND METHODS”. Because credit processing organizations are exposed to potential credit fraud by accepting a merchant as a client, the application process may include an underwriting process wherein the credit processing organization investigates prior cases of suspected or actual fraud with respect to a merchant/applicant.

Merchants may fraudulently use their accounts with a processing organization in many ways. For example, a merchant may process transactions using a personally owned credit card with no intention of paying the credit card bill. However, the merchant would receive payment from the credit processing organization. In another example, a merchant may “sell” charge-backs at reduced rates with no intention of sending the proceeds to the credit processing organization. However, the accounts of the recipients of the charge-backs would be credited by the credit processing organization. Selling fictitious merchandise is also fraudulent. There are many other examples of fraudulent use of credit accounts. During the underwriting process, credit underwriters attempt to discover a merchant's propensity for having committed such acts in the past and/or any motivation to commit such acts in the future.

Once a merchant is accepted as a client and the merchant begins accepting credit cards and other presentation instruments for payment, a credit processing organization may choose to monitor the activities of the merchant with respect to the transactions within which the merchant participates. The transactions may include both sales of goods and services and credits for goods and services returned or refused. The transactions may also include payments by the credit processing organization to the merchant. For convenience, sales and returns will be referred to herein as “charges” and “charge backs”. The types of transactions a merchant participates in, the goods or services purchased in the transactions, and the customers with whom the merchant transacts all warrant observation to identify any cases of suspected credit fraud. Thus, the present invention provides systems and methods for more efficiently monitoring for credit fraud by tacking and analyzing this transaction information associated with merchant-customers.

According to the present invention, financial data, including merchant transaction information, is recorded over time for the merchants doing business with the credit processing organization. Periodically, the transaction history is reviewed for indications of credit fraud. Based on the periodic review, some merchants may be flagged for credit review using specified criteria. The criteria may be customized according to the needs of the credit issuing entity. Merchants may be flagged either through manual or automated review processes. Thus, the present invention periodically produces a list of merchant accounts to be reviewed.

Once identified for review, merchant accounts are forwarded to credit fraud investigators who may collect additional information and evaluate the reasonableness of the potentially fraudulent activity. With respect to a merchant's account, it may be the case that no actual fraud is taking place. It may also be the case that the credit fraud investigator is unable to conclude whether the merchant is acting fraudulently. However, the investigator may also conclusively determine that the merchant is committing some form of fraud that requires further action. In either of the latter cases, the investigator has a number of possible alternatives.

If the credit fraud investigator is unable to dismiss potentially fraudulent activity relating to a merchant's account, the investigator may place the merchant on a “watch list.” Additionally, the credit fraud investigator may alert collections officers, which would also be the appropriate action if the investigator is able to confirm that the merchant is committing fraud. Systems and methods for managing collections issues with respect to merchant accounts are more fully explained in previously incorporated U.S. patent application Ser. No. 10/108,785, entitled “SYSTEMS AND METHODS FOR MANAGING COLLECTIONS RELATING TO MERCHANT ACCOUNTS”. In any case, the investigator may create a permanent file relating to the merchant's account, to include the observations and findings of the investigator, the file to be maintained for future reference.

The present invention provides the ability to operate the credit fraud evaluation system across a network such as the Internet. For example, the recording of merchant transactions and the electronic evaluation of the transactions may be performed at a server computer. The review list may be transmitted to one or more investigators' computers, which may also be used by the investigators to access merchant information from the server computer. A web site browser environment may be used to interact with the server computer in a manner well known to those skilled in the art. For example, managers may access reports from locations different from the location of the server computer or any investigators' computers.

The process by which an investigator goes about reviewing merchants' accounts may be further facilitated through the use of a decision tree. Decision trees are more fully explained in previously incorporated U.S. patent application Ser. No. 10/108,781, entitled “DECISION TREE SYSTEMS AND METHODS”. Thus, the credit processing organization may substantially reduce the cost of labor for monitoring credit fraud by employing less skilled administrative personnel to accomplish tasks typically reserved to investigators.

The present invention also provides a significant reporting capability. Reports may be generated for a variety of reasons. For example, reports may list all the merchants on the watch list or all the merchants whose accounts were transferred to collections officers. Reports may also list the reviews completed, in order to monitor the efficiency of investigators. Many other reports are possible.

Having described the present invention generally, the invention will be described in more detail using a specific, non-limiting example. Although the examples herein relate to credit processing organizations, the present invention is in no way limited by these examples.

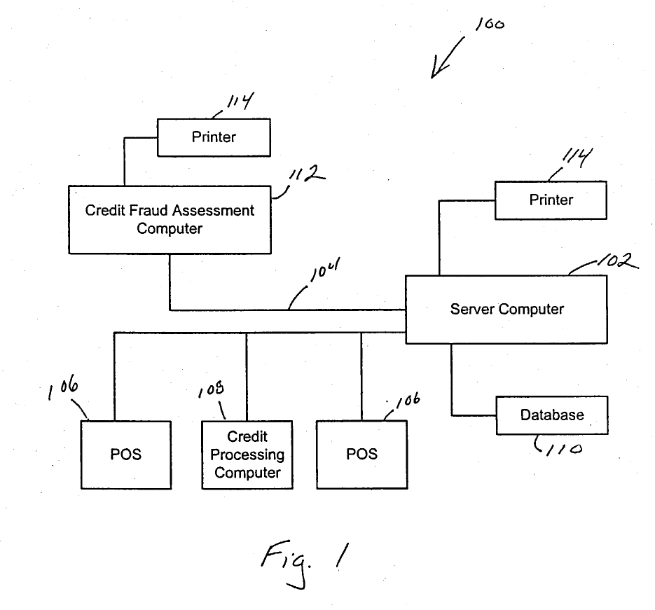

Referring to FIG. 1, a first embodiment of a system 100 for monitoring credit risk is illustrated. The system 100 includes a server computer 102 connected to a network 104. The server computer 102 may be any of a number of computing devices known to those skilled in the are, such as, for example, a personal computer, a workstation, or the like. In some embodiments, the server computer 102 comprises a host computer system. Application programs residing on the server computer 102 allow the server computer to send and receive files from other computing devices. A suitable interface, as is known in the art, allows the server computer 102 to communicate with other devices via the network 104. The network 104 may be, for example, a wide area network, a local area network, the Internet, or the like.

The server computer 102 is configured to receive merchant credit transaction information from one or more point of sale deices 106 or credit processing computers 108. The server computer 102 causes the transaction information to be stored on a data storage arrangement. The data storage arrangement, or database 110, may be any one or a combination of well known types of recording media, including, for example, magnetic tape, disk drives, optical storage systems and the like. The database 110 may be integral to the server computer 102 or located elsewhere such that the server computer 102 accesses the database 110 via a network.

Through the network 104, the server computer 102 is able to exchange information with one or more credit fraud assessment computers 112. For example, the server computer 102 periodically generates a list of merchants whose accounts should be reviewed and transmits the list to the credit fraud assessment computer 112. A user, such as an investigator, at the credit fraud assessment computer 112 may develop information relating to a merchant's account and transmit the information to the server computer 102 for storage in the database 110. The server computer 102 may also respond to commands from the credit fraud assessment computer 112 to generate one or more reports, which the server computer 102 transmits to the credit fraud assessment computer 112. Thereafter, the credit fraud assessment computer 112 may respond to commands from a user to output the report on, for example, a printer 114.

The server computer 102 and/or the credit fraud assessment computer 112 may be configured more specifically to perform the methods of the present invention and employ the graphical user interface to be described hereinafter. It merits noting that in some embodiments of the present invention the server computer 102, the credit fraud assessment computer 112 and the database 110 exist together in a single computing device.

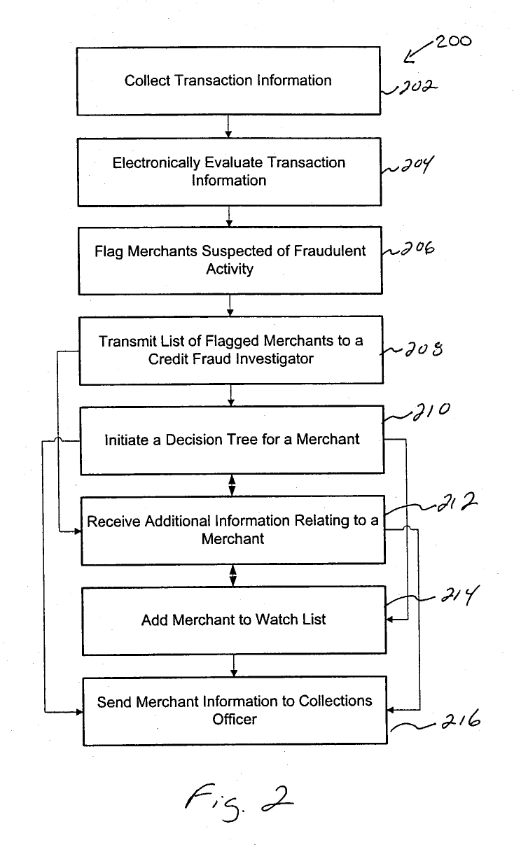

Referring to FIG. 2, a first embodiment of a method 200 of monitoring credit fraud according to the present invention is illustrated. The method may be carried out, for example, on a server computer such as the server computer 102 of FIG. 1. At operation 202, transaction information is collected relating to merchant's accounts. The transaction information may include, for example, the merchant account number, an itemization of the goods or services sold, to whom the goods or services were sold, the date and time of the transaction, and the value of services charged or charged back in the transaction. The information is stored for later evaluation.

At operation 204, the transaction information is electronically evaluated using specified criteria. For example, the specified criteria may include identifying merchants processing transactions with their own personal charge accounts, merchant's selling goods or services outside their business area, merchants with excessive charge back volume, and the like. Other examples include merchants processing altered or counterfeit cards, merchants processing cards in violation of certain contract provisions, merchants participating in professional credit card scams, merchants processing invalid credits, merchants processing credit cards reported as lost or stolen, and merchants operating businesses for the purpose of creating excessive credit volume and dissolving the business. At operation 206, merchants suspected of potentially fraudulent activity are flagged.

At operation 208, at least a partial list of merchants is provided to a credit fraud investigator. The investigator has access to merchants' account information, as well as merchants' transaction information. The investigator may also have access to information relating to prior cases of expected fraud relating to a merchant. The investigator may select a merchant from the list and begin an evaluation in either of two ways. At operation 210 the investigator may initiate a decision tree to assist with the review of the merchant's account. As further explained in previously incorporated U.S. patent application Ser. No. 10/108,781, entitled “DECISION TREE SYSTEMS AND METHODS”, a decision is an ordered approach to accomplishing a business process through the use of a computer tool. Interacting with, for example, the server computer, the investigator may use the decision tree tool to facilitate the development of a file relating to a merchant suspected of fraudulent activity. As the information is added to the file, the path through the decision tree may change based on information entered. The decision tree may culminate in, for example, an instruction to the investigator to transmit the merchant account information to a collections officer. Many other possible uses for a decision tree in this context are possible.

Alternatively, the investigator may collect additional information relating to the merchant using a series of display data screen in, for example, a web browser environment and transmit the information for receipt at the server computer as indicated by operation 212. Specific, non-limiting examples of display screens to be used will be described in more detail hereinafter.

As a result of either operation 210 or 212, a merchant may be added to a watch list at operation 214. If, for example, the investigator is unable to conclude whether the merchant is acting fraudulently, the investigator may decide to have the merchant reviewed, or watched, periodically. Thus, after additional transaction information is collected relating to the merchant, the account may be reviewed again. If the investigator is able to determine that the merchant is acting fraudulently, then the investigator may refer the account to a collections officer as indicated by operation 216. The collections officer may initiate a number of actions with respect to a merchant's account, as more fully explained in previously incorporated U.S. patent application Ser. No. 10/108,785, entitled “SYSTEMS AND METHODS FOR MANAGING COLLECTIONS RELATING TO MERCHANT ACCOUNTS”.

At operation 218, reports may be requested relating to the credit fraud investigation process. As previously discussed, reports may list merchant assigned to a watch list or forwarded to collections. Reports may also be used to track the efficiency of fraud investigators. Many other reports are possible.

As stated previously, the present invention may include a web browser environment that allows credit fraud investigators to recall and evaluate merchant account and transaction information over a network. FIG. 3 illustrates a first screen display 300 that may be used by an investigator in this process. Screen display 300 is a query screen to select merchants having data matching a particular query. For example, an investigator may recall merchant accounts using the merchant number field 302 or using the DBA, or “doing business as” name field 304. Many other possibilities exist. Action field 305 recalls merchants according to the decision made relating to their account. Risk field 306 recalls merchants according to risk levels previously assigned by an analyst. Assigned to field 308 recalls merchants according to the investigator to whom the account is assigned. Fraud type field 310 recalls merchants according to the type of fraud involved. Data fields may also be provided to identify merchants by type, or by a portfolio to which the merchant is assigned. Fields may also be provided to recall merchant accounts according to dates the merchants were identified for review, dates decisions were made relating to the merchants, and dates reviews and actions were completed. Thus, the query screen 300 may be used after reviews are completed to recall merchants reviewed previously. A submit button 340 sends the query data to a server computer to extract the requested merchant accounts.

FIG. 4 illustrates a display screen 400 that results from selecting the submit button. Merchants having account information matching the query appear in a list 402. The list includes summary information relating to the merchant from which the investigator may make decisions relating to the account. However, the investigator has a number of options relating to each listed merchant account for gathering more information. For example, each merchant account number acts as a hyperlink 404 to additional display screens, as will be explained further. Alternatively, the investigator may select a hyperlink 406 to initiate a decision tree. If the investigator desires to monitor the merchant's activity, the investigator may select an add icon 408 to add the merchant to a watch list.

FIGS. 5A-E depict a series of display screens that are rendered in response to selecting the account number hyperlink 404 from FIG. 4. Access to the screens may be security controlled, allowing, for example, only managers to have access to one or more of the screens. The first of these, managers screen 500 of FIG. 5A, which may be rendered by selecting the managers screen tab 501, includes a number of data fields for entering and/or reviewing information relating to the merchant and the particular circumstances of the merchant's selection for credit fraud review. For example, the name field 502, address field 504, merchant # 506 field, corporate name field 508, and the SIC code field 510 all serve to identify the merchant and specific information about the merchant. The signor ID field 511 identifies the sales person who acquired the merchant as a client. The inclusion of this field allows managers to observe for trends relating sales persons to fraudulent merchants. The date identified field 512 contains the date that the merchant was flagged for review. The source field 514 provides an indication of which flag triggered the review. The priority field 516 provides an indication of the seriousness of the anomaly that triggered the review. The assigned to field 518 identifies the investigator performing the investigation. The work of date field 520 contains the date the investigator completes the review. The merchant funding flag(s) field 522, the merchant DDA set to field 524 and the diversion/suspense 99 day hold field 526 together provide an indication of how quickly the credit processing organization typically pays the merchant and whether the organization is maintaining funds in reserve prior to paying the merchant. The merchant type field 528 allows choices of brick & mortar/point of sale, internet/mail-order/telephone-order, or tier II. The previous FTMS review field 529 identifies whether the merchant has been flagged for review previously. The prior days hold ACH setting field 530 is a notation flag that the mainframe ACH has been placed on hold. The chain field 532 identifies whether the merchant in question is related to other merchants as a chain. The reason for review field 534 provides the investigator with a free form text area to enter information relating to the merchant and the investigation. Some of the data fields in the display screen 500 may be completed for the investigator based on the account information on file; other fields may be blank, which the investigator completes as part of his investigation. A submit button 536, shown on FIG. 5B transmits the information entered by the investigator to a server computer for storage. A delete button 538 and a cancel button 540 remove information from the merchants file and abort the operation, respectively.

Selecting the merchant info tab 542 causes the merchant info display screen 544 of FIG. 5B to be rendered. Many of the fields contain similar data to the managers screen 500. Additional fields include the date on board field 546 that identifies the date the organization began processing transactions for the merchant. The product/service field 548 identifies the product or service of the merchant's business. The portfolio field 550 identifies the bank involved with transaction for the merchant.

Selecting the financial tab 552 causes the financial display screen 554 to be rendered, as shown in FIG. 5C. The financial display screen 554 includes the signed annual sales field 556 which reflects merchants estimated annual sales dollars. The signed average ticket field 558 reflects merchants estimated average single sale. The YTD net volume field 560 provides the volume of business processed for the merchant in the current year. The current month net volume field 562 provides the volume of business processed for the merchant in the current month. The prior month volume field 564 provides the amount of business processed for the merchant in the previous month. The chargeback % filed 566 provides the percentage of the merchant's volume that is charged back. The retrieval % field 568 relates to charge backs. The keyed % field 570 is percent of sales keyed with credit card number versus percent of sales swiped with actual card. The MOTO field 572 provides the percentage of the merchant's transactions wherein the merchant obtains the customer credit information by mail order or telephone order. The gross risk field 574 provides the amount of money paid out to the merchant for which the processing organization has not received payment. The reserve field 576 identifies the amount of money the processing organization maintains in reserve for the merchant. The net risk field 578 calculates the difference between the gross risk and the reserve.

The status display screen 580 of FIG. 5D is rendered by selecting the status tab 582. In addition to data fields previously identified, the status display screen 580 includes the action field 584 for identifying what action the investigator decided to take with respect to the merchant's account. The decisioned field 586 contains the date the investigator decides what action to take. The fraud type field 588 identifies the type of fraud the investigator discovered. The TMF (terminated merchant file) field 590 is a file to which certain processing merchants committing fraud are added. The file serves to identify previous offenders. The completed date field 592 identifies the date the action was completed.

Selecting the note tab 594 renders the note display screen 596 of FIG. 5E. The note display screen 596 includes a free form text field 598 for entering notes relating to the investigation and the actions taken.

As mentioned previously, the collection and analysis of merchant data relating to the fraud investigation may be facilitated through the use of a decision tree. FIG. 6 illustrates a decision tree structure 602 for conducting a fraud investigation. The structure includes an active node 604, which appears at the top of the structure. The active node is the node to which the investigator must next respond. A response may be entered into a data field such as the alphabetic look-up data field 606, which happens to function as a dropdown menu for responding to a node question 608. A submit button 610 transmits the user's response and causes the next node 612 to become the active node. The decision tree may include subnodes, such as the bad bin listing subnode 614. As previously mentioned, the creation and use of decision trees in such application is more fully explained in previously incorporated U.S. patent application Ser. No. 10/108,781, entitled “DECISION TREE SYSTEMS AND METHODS”.

Selecting one of the add buttons 408 of FIG. 4 renders the add to watch list display screen 700 of FIG. 7. This causes the merchant's account to be flagged for review in a later review period. The display screen includes an added to watch list field 702 for identifying the date that the merchant was placed on the watch list. A reason field 704 identifies the reason for adding the merchant to the watch. The status field 706 identifies whether the merchant is still on the watch list. A next review date field 708 provides for scheduling the next time the merchant should be reviewed. An add button 710 transmits the information to a server computer, and a cancel button 712 aborts the add to watch list function.

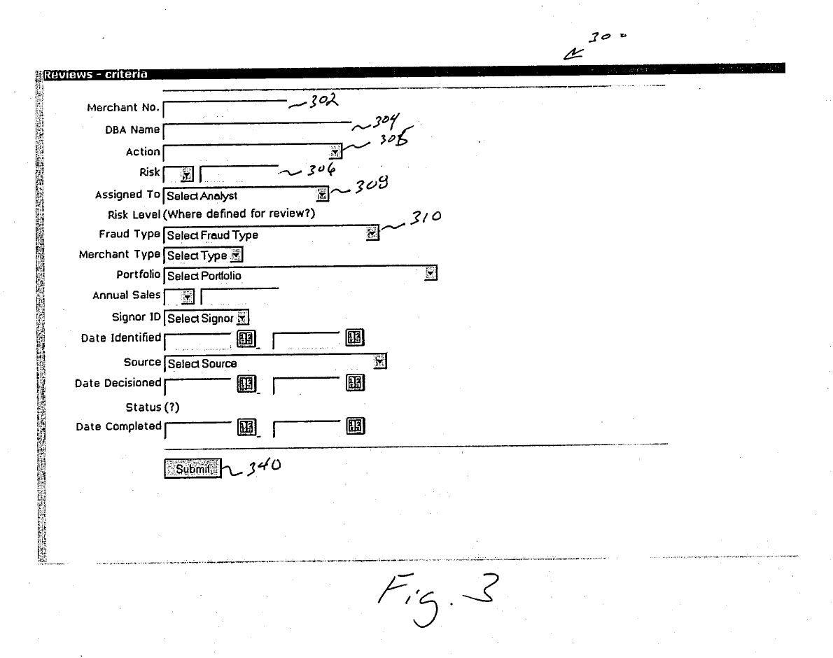

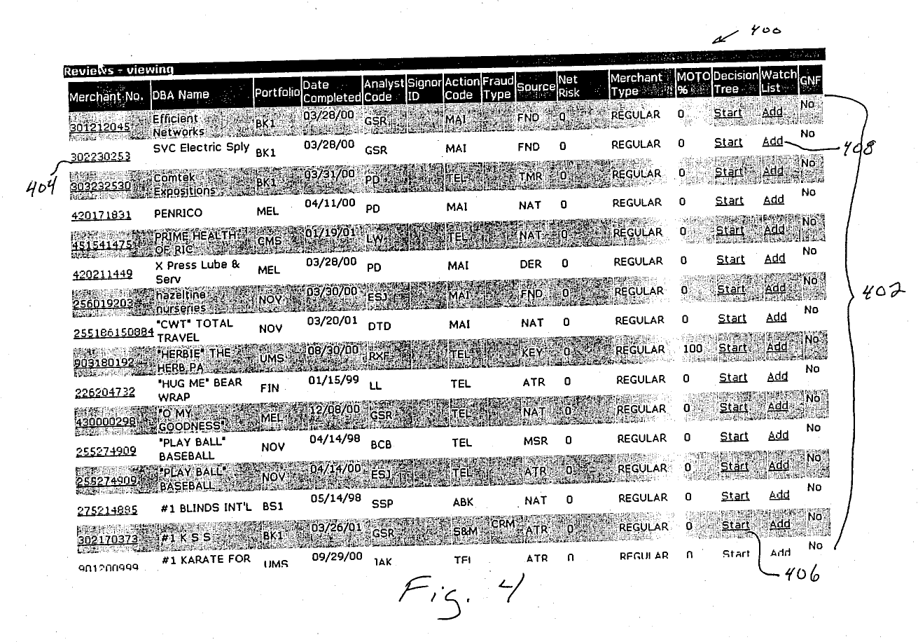

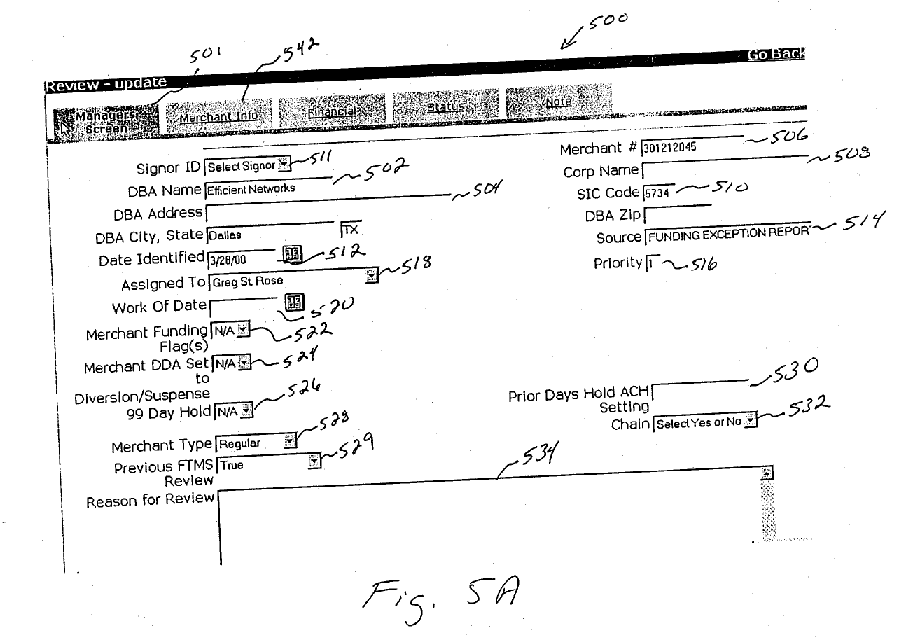

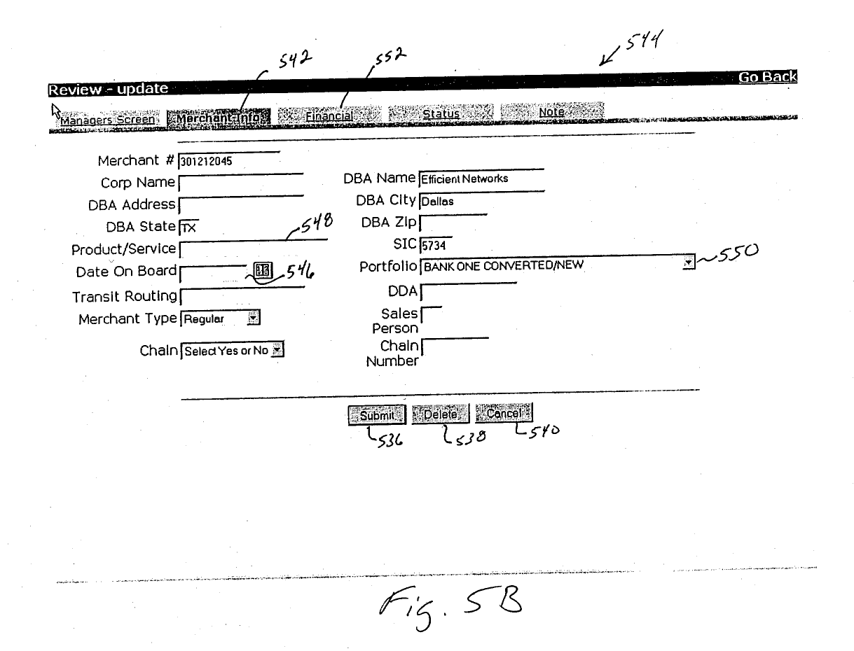

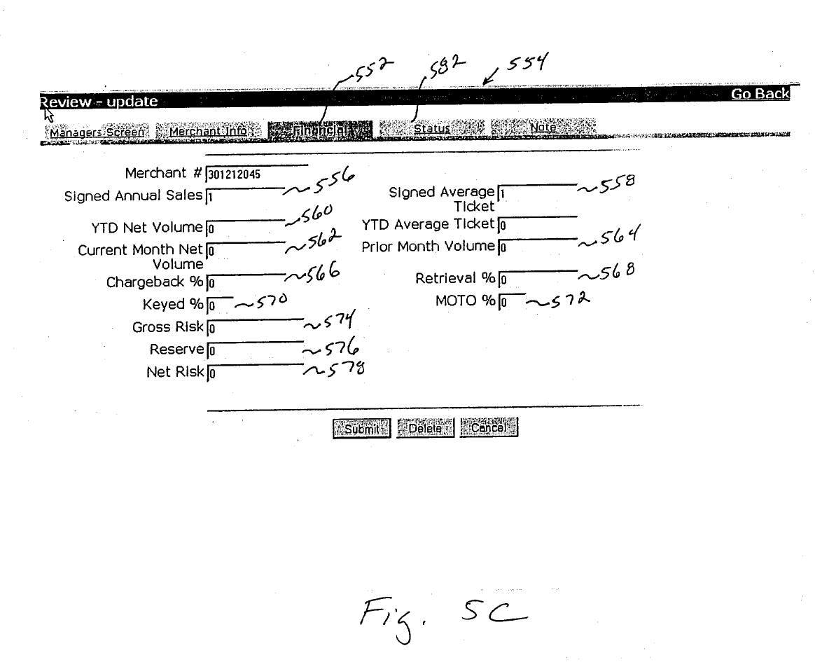

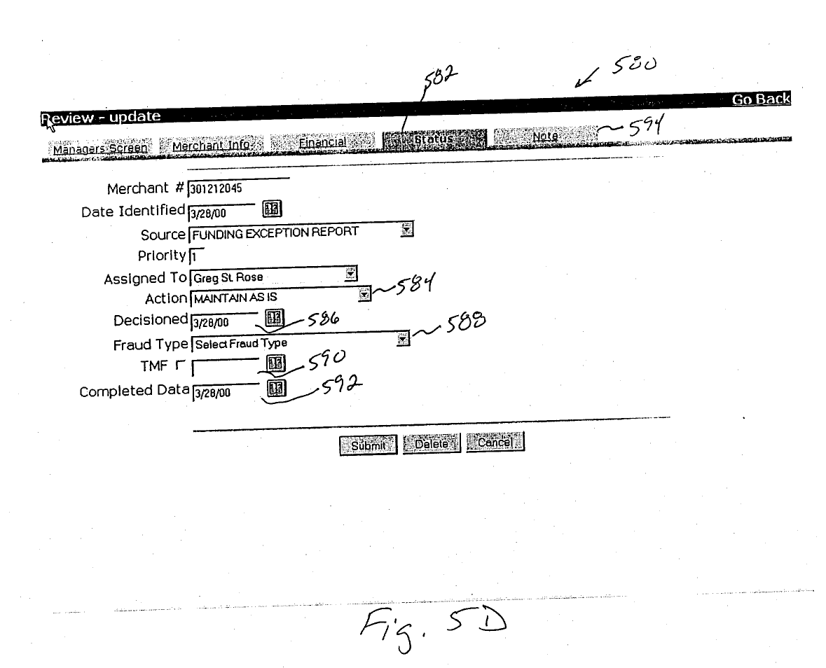

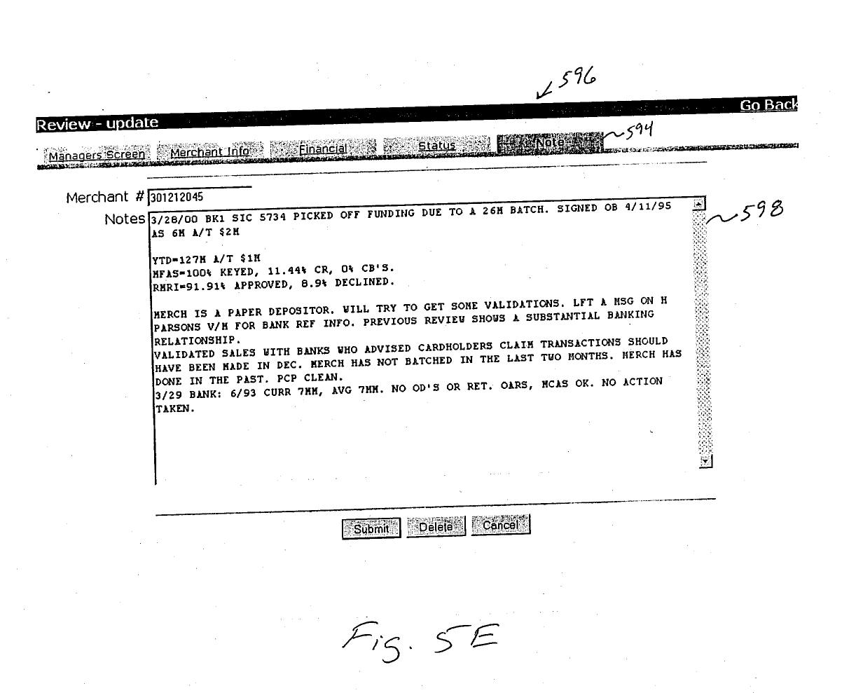

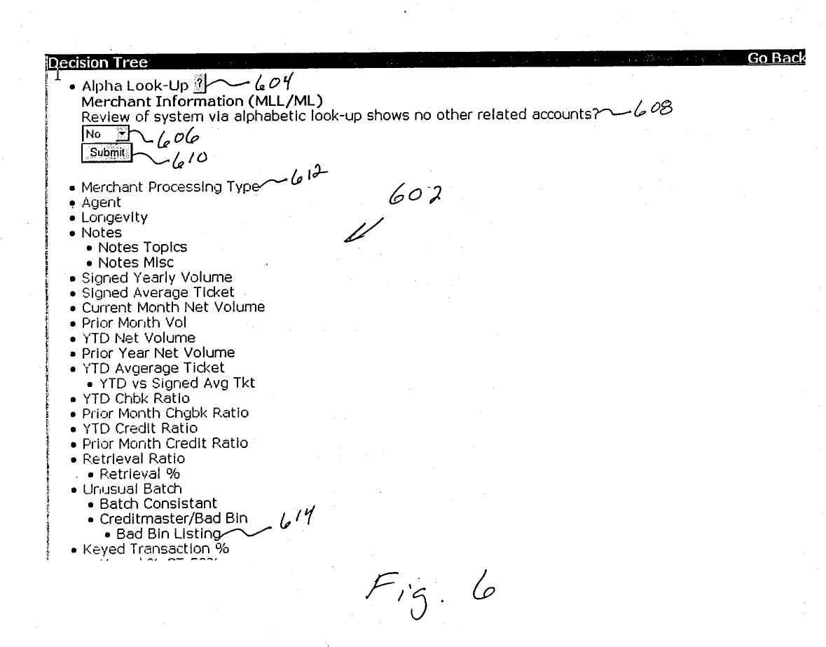

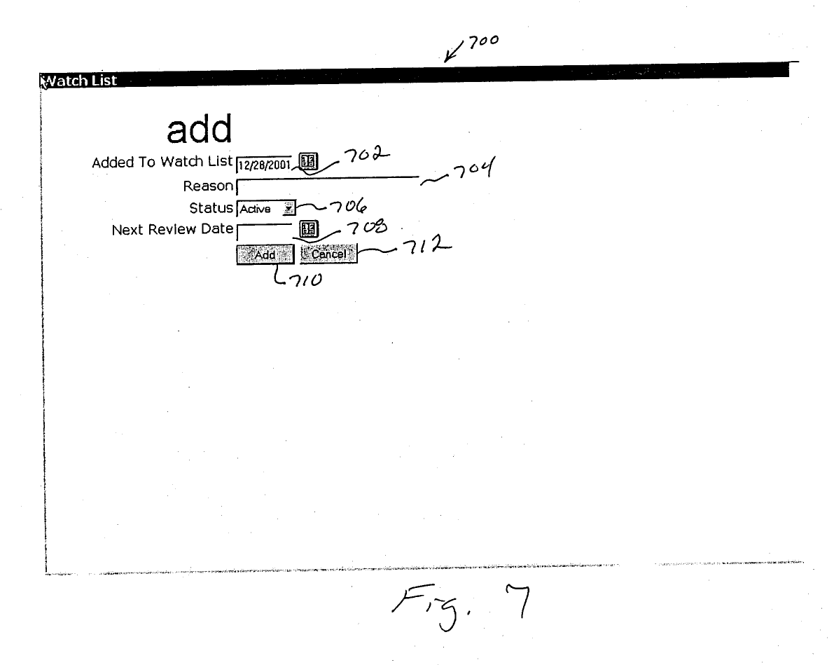

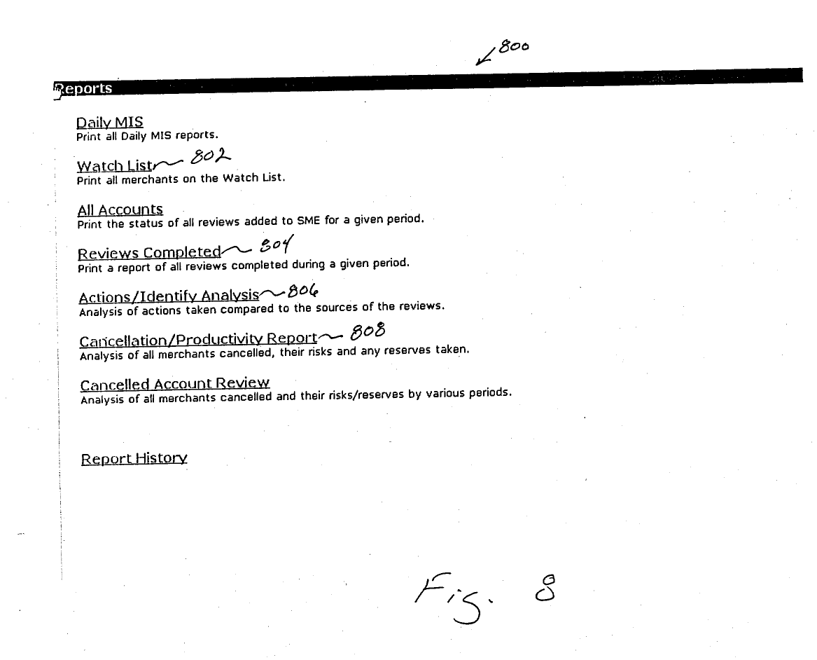

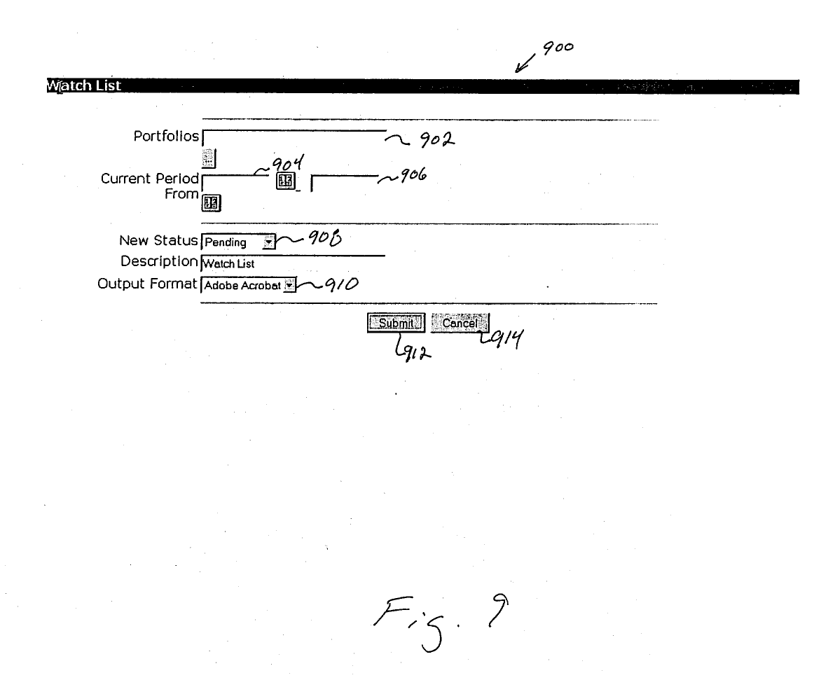

A reports feature provides the ability to obtain greater insight into the fraud investigation process. A reports display screen 800 of FIG. 8 functions a menu for selecting reports. The generation of reports from information stored in a database is well know. In this particular embodiment of the present invention, examples of reports include the following. A watch list report hyperlink 802 provides for the reporting of merchants on the watch list. A reviews completed report hyperlink 804 provides for the reporting of reviews completed during a specified period of time. A actions/identify analysis hyperlink 806 provides for the reporting of results of investigations. A cancellation/productivity report hyperlink 808 provides for the reporting of merchants whose accounts were canceled and particular information about each. Many other reports are possible, depending on the needs and particular situation of the credit processing organization. Each of the hyperlinks mentioned above may be configured to render a more detailed report query screen, one example of which is illustrated in FIG. 9.

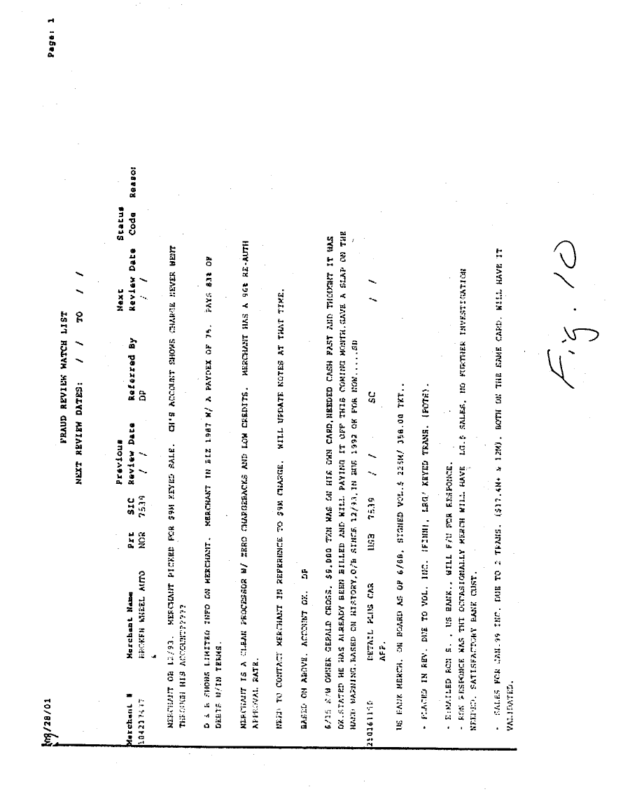

FIG. 9 illustrates a watch list report query screen 900, which provides for the reporting of merchant included on the watch list. A portfolio field 902 allows the report to be limited to only merchants within a particular portfolio. A pair of date fields 904, 906 allow the report to be limited to merchants appearing on the watch list only during a certain period. A new status field 908 provides status of the report in the queue. An output format drop down menu 910 allows the report to be generated in various formats, for example, excel spreadsheet, text document, .pdf, and the like. A submit button 912 initiates the report and a cancel button 914 aborts the action. An example of the report generated through the use of the watch list report query screen 900 is illustrated in FIG. 10.

As stated previously, the present invention is not limited to monitoring fraudulent activity with respect to credit services. The accounts of other sellers and their associates also may be monitored. For example, money transfer service providers may enlist the assistance of merchants, retailers, or other associates to collect and dispense money. The associates collect money from individuals wishing to transfer, or “wire,” money to another person or business. However, such services may be used for fraudulent activities, and the service providers themselves may be the victims of fraud from their associates or customers.

According to the present invention, transaction records relating to money transfers are collected at a host computer system. Periodically the host computer system evaluates the transaction records using specified criteria designed to identify potentially fraudulent transactions or groups of transactions. If the criteria is satisfied, the accounts involved are identified for further evaluation by analysts trained to gather additional information, make determinations as to whether fraudulent activity is taking place, and institute measures designed to stop the activity. As an example, sequential transactions below a reporting threshold may indicate fraudulent attempts to avoid reporting cash transfers, as might multiple transactions to or from the same individual or business. An unusual fluctuation in the volume or number of transactions during a particular time of day, day of the week, or even season of the year also may indicate potentially fraudulent activity by an associate or service user. Similar criteria may be used to attempt to identify fraudulent activity with respect to money order sellers or bill payment service providers acting on behalf of money transfer service providers.

In still other embodiments of the present invention, accounts relating to rental agents may be monitored. These accounts are particularly subject to fraud since the rental items remain in inventory. For example, a store that rents movies may be a victim of fraud committed by the workers. The workers may take money from customers without recording the transaction. Because the majority of rented movies are returned, the “off-book” transaction, in all likelihood, will go unnoticed. However, by comparing rental activity among periods, unusual fluctuations may become apparent. In a related example, a clerk may process refunds on returned movies and pocket the money. Because the movie is back in inventory and the customer is no longer involved, such fraudulent activity also may avoid detection. However, according to the present invention, the transaction records for the store may be monitored for unusual fluctuations in rental activity or refunds. If such is discovered, additional monitoring activities may be implemented to attempt to isolate the activity to a particular shift or employee. Of course, similar measures may be implemented on other types of rental merchandise or even merchandise offered for sale.

In still other embodiments of the present invention, fraudulent activity with respect to the dispensing of representative value instruments may be monitored. For example, many entities dispense pre-paid cards, such a long distance cards, vouchers, gift certificates, coupons, and the like. Such instruments have value, yet do not typically require a presenter to provide identifying information upon redemption. Thus, such instruments may be particularly susceptible to fraud. According to the present invention, however, the accounts of those responsible for dispensing the instruments may be monitored. By observing the dispenser's inventory of such instruments or fluctuations in the income derived from issuing them, potentially fraudulent activity may become apparent.

In still other embodiments, banks or other financial institutions may be victimized, for example, at automated teller machines (ATMs). By evaluating deposits, withdrawals, and transfers at ATMs, unusual activity may be identified and evaluated further for potential instances of fraud. The evaluation criteria used may relate to the location of the ATM, the time of day the transactions are taking place, and the like. Many other examples of monitoring electronic accounts using specified criteria are possible.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers through the use of web-browser software. Accordingly, the above description should not be taken as limiting the scope of the invention, which is defined in the following claims.

What is claimed is:

1. A method of monitoring electronic accounts for fraudulent activity, comprising:
compiling transaction records at a host computer system;
evaluating the transaction records for potentially fraudulent activity using specific criteria; and
flagging accounts having transaction records indicating potentially fraudulent activity.

2. The method of claim 1, further comprising seasonally adjusting the specific criteria.

3. The method of claim 1, wherein the specific criteria includes a factor relating to a time of day in the transaction records.

4. The method of claim 1, wherein the electronic accounts relate to money transfer service providers.

5. The method of claim 4, wherein the specific criteria relates to a number of money transfers processed by one of the money transfer service providers over a period of time.

6. The method of claim 4, wherein the specific criteria relates to a volume of money transferred by one of the money transfer service providers over a period of time.

7. The method of claim 1, wherein the electronic accounts relate to money order sellers.

8. The method of claim 7, wherein the specific criteria relates to a sum of money orders purchased in different transactions, wherein a money order purchased in each individual transaction is less than a reporting threshold, and wherein the sum exceeds the threshold.

9. The method of claim 1, wherein the electronic account relates to a bill payment service provider.

10. The method of claim 1, wherein the electronic accounts relate to rental service providers.

11. The method of claim 10, wherein the specific criteria relates to a volume of rental activity.

12. The method of claim 10, wherein the specific criteria relates to a volume of refunds.

13. A system for monitoring fraud relating to a plurality of electronic accounts, comprising:
a data storage arrangement; and
a host computer system configured to access the data storage arrangement;
wherein the host computer system is adapted to communicate with at least one other computer through a network, wherein the host computer system is configured to compile transaction records relating to the electronic accounts and evaluate the transaction records for potentially fraudulent activity using specified criteria, wherein the host computer system is further configured to flag accounts having transaction records indicating potentially fraudulent activity.

14. The method of claim 13, wherein the electronic accounts relate to money transfer service providers.

15. The method of claim 13, wherein the electronic accounts relate to money order sellers.

16. The method of claim 13, wherein the electronic account relates to a bill payment service providers.

17. The method of claim 13, wherein the electronic accounts relate to rental service providers.

18. A fraud monitoring computer, comprising:
means for receiving and storing electronic transaction records relating to account holders, wherein the electronic transaction records include transaction data relating to transactions;
means for periodically evaluating the transaction records using specified criteria;
means for identifying particular accounts whose transaction records indicate potentially fraudulent activity based on the specified criteria.

19. The computer of claim 18, wherein the account holder comprises a money transfer service provider.

20. The computer of claim 18, wherein the account holder comprises a rental services provider.
